(19) United States
(12) Patent Application Publication
(10) Pub. No.: US 2001/0039694 A1
(43) Pub. Date: Nov. 15, 2001

(54) HINGE RETARDING DEVICE SUCH AS FOR VEHICLE GLOVE COMPARTMENT LIDS

(76) Inventor: PIETRO CAU, TORINO (IT)

Correspondence Address: LOWE HAUPTMAN GOPSTEIN GILMAN & BERNER, 1700 DIAGONAL ROAD, SUITE 310, ALEXANDRIA, VA, 22314, US

(21) Appl. No.: 09/296,400

(22) Filed: Apr. 23, 1999

(30) Foreign Application Priority Data
Apr. 24, 1998 (IT) TO98A 000355

(51) Int. Cl. E05F 1/14

(52) U.S. Cl. 16/285

(57) ABSTRACT

A retarding device insertable between two members connected to rotate relatively about a hinge axis, and which opposes and so retards such rotation in predetermined manner; the device having: a substantially cylindrical support carried integrally by a first of the rotationally connected members and substantially coaxial with the hinge axis; a coil spring fitted interferentially to the support and terminating with two opposite radial arms projecting towards a second of said members connected to each other for relative rotation; and a retaining seat carried integrally by the second member and on which the arms of the spring rest, on opposite sides, and are stressed by the second member, as a consequence of the aforementioned relative rotation, to deform the spring in such a direction as to reduce the interference with which the spring is fitted to the support.

The present invention relates to a hinge retarding device, in particular for vehicle glove compartment lids. More generally, the retarding device according to the invention is suitable for insertion between any two relatively rotating members to brake rotation of the members in controlled manner.

### BACKGROUND OF THE INVENTION

Some applications call for retarding the relative rotation of two members to maintain rotation below a predetermined speed. One of the most common examples is a vehicle glove compartment lid. For example, when the lock is clicked open, some lids are opened automatically by a spring, which is loaded when the lid is pushed shut by the user; in which case, the retarding device prevents the lid from springing open violently. In other cases, the lid is lifted open by the user and clicked into a limit position, normally defined by a stop mechanism; in which case, the retarding device prevents the lid from dropping down sharply into the closed position (under its own weight and/or by the thrust exerted by a contrast spring) when the stop mechanism is released.

The above problems are currently solved using retarding devices which are either fitted to the hinges or connected to the moving member, and which provide, in controlled manner, for braking rotation either in both (open and close) directions or only in the direction of the sharp movement which might endanger the safety of the user. Retarding devices are substantially of two types. A first comprises a friction mechanism (normally mechanical) in turn normally comprising facing spring-loaded friction members which rub against each other during the movement to be retarded, so that part of the energy produced during the movement must overcome the friction between the friction members, thus greatly reducing the force applied to, and acceleration of, the moving member. A second type comprises a hydraulic mechanism in which one or more gears, connected to the moving member to be braked, are rotated immersed in a thick fluid (e.g. silicone oil).

Retarding devices of both the above types have numerous drawbacks: both are expensive and bulky, and neither can be integrated with the hinge structure. Moreover, friction devices are mechanically complex, are not always reliable, and are subject to wear; while hydraulic devices are subject to leakage, and, above all, vary in performance according to ambient temperature (which affects the density of the oil and hence the extent to which the movement is retarded).

### SUMMARY OF THE INVENTION

It is an object of the invention to provide a retarding device which is straightforward and cheap to produce, is extremely compact, may be integrated with a hinge, is reliable, and is unaffected by variations in ambient temperature.

According to the present invention, there is provided a retarding device insertable between two members connected to rotate relatively about a hinge axis; said device being designed to oppose and so retard such rotation in predetermined manner, and being characterised by comprising:

a substantially cylindrical support carried integrally by a first of the rotationally connected said members and substantially coaxial with the hinge axis;

a coil spring fitted interferentially to the support and terminating with two opposite radial arms projecting towards a second of the rotationally connected said members; and

a retaining seat carried integrally by said second member and on which the arms of the spring rest, on opposite sides, and are stressed by the second member, as a consequence of relative rotation of said members about the hinge axis, to deform the spring in such a direction as to reduce the interference with which the spring is fitted to the support.

More specifically, the spring is fitted to a cylindrical lateral surface of a pin having a diameter greater than the inside diameter of the spring when undeformed; and the pin is fitted to the first member by a prismatic joint preventing rotation of the pin with respect to the first member.

Consequently, when the two members are rotated relatively, one or the other (depending on the direction of relative rotation) of the two arms of the spring—which rest laterally on respective opposite faces of the retaining seat parallel at all times to the tangents to said lateral surface of the pin—is subjected to a torque reaction which tends to elastically increase the winding diameter of the spiral defined by said coil spring.

When relaxed, the spring may therefore also be rotated with respect to the pin, but very slowly on account of the strong internal friction produced by the elastic deformation, so as to retard relative rotation of the two members as required. The braking action is proportional to the diameter of the music wire from which the spring is made, and to the ratio between the inside diameter of the turns of the spring at rest and the outside diameter of the pin to which the spring is fitted, i.e. to the amount of interference.

The device according to the invention is therefore extremely straightforward and cheap to produce, is easy to assemble (by simply inserting the spring with a tool and fitting the spring onto the pin by evolvent deformation), is active in both rotation directions, and is compact and integrated easily with the hinge, the pin of which, defining the hinge axis, may for example be fitted through the pin supporting the spring to define a single retarded hinge assembly. What is more, the braking action is unaffected by ambient temperature, there are no leakage problems, and operation is fully reliable.

The pin to which the spring is fitted need not, of course, necessarily be cylindrical, and may be prismatic, oval or elliptic, providing the shape permits deformation and rotation of the spring.

### BRIEF DESCRIPTION OF THE DRAWINGS

A non-limiting embodiment of the present invention will be described by way of example with reference to the accompanying drawings, in which:

FIG. 1 shows a schematic elevation of a retarding device in accordance with the invention and integrated with a hinge;

FIG. 2 shows a cross section of the FIG. 1 device and hinge.

### DETAILED DESCRIPTION OF THE INVENTION

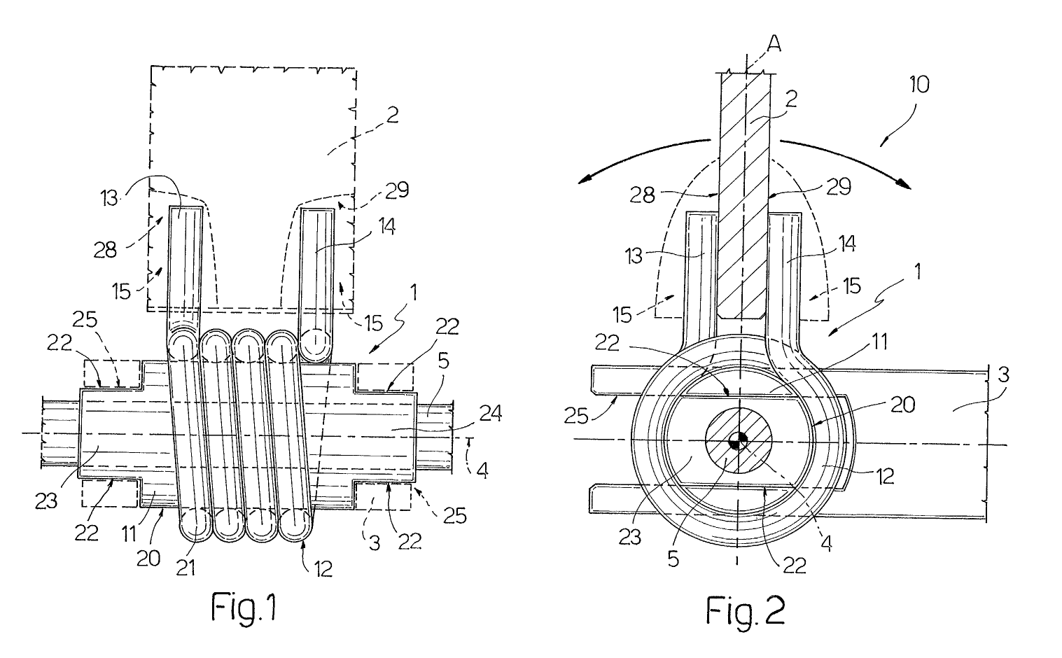

Number 1 in FIGS. 1 and 2 indicates as a whole a retarding device, which is insertable between two members 2, 3 connected to rotate relatively about a hinge axis 4, and which, as will be seen, opposes and so retards rotation of the members in predetermined manner. Members 2, 3 may be any two members movable with respect to each other, e.g. a lid closing an access opening (e.g, to a vehicle glove compartment) and a post defining said opening, or may form part of a hinge device 10 (FIG. 2) hinging the members and integrated with retarding device 1, in which case, members 2, 3 are defined by two half-hinges (e.g. a movable and a fixed half-hinge) connected by a pin 5 to rotate about hinge axis 4.

According to the invention, device 1 comprises a support 11 carried integrally by one of members 2, 3 (in the example shown, member 3) and substantially coaxial with hinge axis 4; a coil spring 12 fitted interferentially to support 11 and terminating with two opposite radial arms 13, 14 projecting towards the other member (in the example shown, member 2); and at least one retaining seat 15 carried integrally by member 2, and on which arms 13, 14 of spring 12 rest on opposite sides.

In the non-limiting example shown, member 2 is assumed to be the movable member (rotating about axis 4), and member 3 the fixed member, though the following description also applies conversely. Moreover, though support 11, in the non-limiting example shown, is defined by a substantially cylindrical pin defined by a cylindrical outer lateral surface 20 coaxial with axis 4, it is understood that any support of substantially axial extension and symmetry may perform the same function as cylindrical pin 11.

According to the invention, spring 12 is fitted interferentially to cylindrical surface 20 and is made from circular-section music wire 21 of a predetermined diameter, by winding wire 21 into a coil (defining spring 12) defined by a number of turns and having an inside diameter, when undeformed, smaller than the outside diameter of pin 11 at surface 20.

According to the invention, pin 11 is fitted integrally and connected angularly to member 3 by prismatic joints defined by circumferential flat surfaces 22 formed on respective opposite ends 23, 24 of pin 11, which are fitted inside respective complementary prismatic seats 25 formed integrally in member 3. Pin 11 is preferably molded in one piece from plastic material, or may be made of metal.

Arms 13 and 14 are defined by respective bent ends of spring 12, which rest laterally—each without crossing the plane of member 2 (indicated A in FIG. 2) —on respective opposite faces 28, 29 of retaining seat/s 15 (FIG. 2). In the simplest embodiment, retaining seat 15 for both arms 13, 14 is defined simply by faces 28, 29, which also define member 2 as a whole. Alternatively, provision may be made for one or more seats 15 (shown schematically by the dash lines) comprising, for example, concavities or appropriate conformations of member 2 and defined partly by faces 28, 29.

Whichever the case, according to the invention, faces 28, 29 are so formed as to be parallel at all times to the tangents to lateral outer surface 20 of pin 11, so as to rotate relatively about axis 4 in either of the two directions indicated by the arrows in FIG. 2, whenever members 2 and 3 are rotated relatively. As such, in the case of clockwise rotation, face 29 intercepts and rotates arm 14, and face 28 does the same with arm 13 in the case of anticlockwise rotation.

In the example shown, the two rotationally connected members 2, 3 defining hinge device 10 are connected to each other by pin 5, which is fixed to and angularly integral in known manner with member 2 (as shown by the hatching in the same direction in FIG. 2) and also defines hinge axis 4. Pin 5 is fitted coaxially through pin or support 11, which is therefore tubular, substantially cylindrical, and free to rotate with respect to pin 5, or to remain stationary with member 3 as member 2 rotates. The same result is achieved if pin 5 is also fixed (e.g. forms an integral part of pin 11) and member 2 is connected idly to pin 5 by appropriate seats.

Whichever the case, by virtue of the structure described, retarding device 1 (and retarded hinge device 10 as a whole) operates as follows.

Normally, spring 12 is wound tightly about pin 11, thus preventing any rotation between the two.

When member 2—either acted on manually by the user, or by virtue of the thrust exerted by elastic means, or under its own weight—begins rotating about axis 4 in either of the two directions shown by the arrows in FIG. 2, it stresses one of arms 13, 14, which, at rest, rest against opposite faces 28, 29 which, for the reasons described, rotate integrally with member 2. Consequently the arm 13, 14 involved (depending on the rotation direction) is subjected by member 2 to a torque reaction, which is directly proportional to the rotation angle, and which elastically increases the winding diameter of the spiral defined by coil spring 12.

In other words, the torque transmitted to arms 13, 14, whichever the direction of rotation, tends to elastically deform spring 12 in such a direction as to reduce the interference with which the spring is fitted to support 11, so that the spiral formed by spring 12 “opens” to enable spring 12 to rotate with respect to pin 11 and together with member 2. However, the energy required to elastically deform spring 12 sufficiently to enable the spring to rotate dissipates a large part of the energy acting on member 2, so that rotation of member 2 is retarded in direct proportion to the initial interference and the elastic twisting force absorbed by the spring (depending on the diameter of wire 21) during deformation.

The same principle, according to a variation not shown, could also be applied in reverse, e.g. by housing a coil spring interferentially inside a cylindrical seat from which the arms project, and by connecting the arms to the movable member so that, during relative rotation, the arms subject the spring to such a torque as to elastically close (i.e. reduce the diameter of) the spiral. Clearly, however, the preferred embodiment described is much easier to assemble.

1. A retarding device insertable between two members connected to rotate relatively about a hinge axis; said device being designed to oppose and so retard such rotation in predetermined manner, and being characterised by comprising:
a substantially cylindrical support carried integrally by a first of the rotationally connected said members and substantially coaxial with the hinge axis;
a coil spring fitted interferentially to the support and terminating with two opposite radial arms projecting towards a second of the rotationally connected said members; and
a retaining seat carried integrally by said second member and on which the arms of the spring rest, on opposite sides, and are stressed by the second member, as a consequence of relative rotation of said members about the hinge axis, to deform the spring in such a direction as to reduce the interference with which the spring is fitted to the support.

2. A device as claimed in claim 1, characterized in that said support is defined by a pin defined by a cylindrical outer lateral surface to which said coil spring is fitted interferentially; the inside diameter of the coil defined by said coil spring, when undeformed, being smaller than the outside diameter of said pin at said outer lateral surface of the pin.

3. A device as claimed in claim 2, characterized in that said pin is fitted angularly integral with the rotationally connected said first member by means of prismatic joints defined by circumferential flat surfaces formed on respective opposite ends of the pin, which are fitted inside respective complementary prismatic seats on said first member.

4. A device as claimed in claim 3, characterized in that said pin is molded in one piece from plastic material, or is made of metal material; and said coil spring is formed by spirally winding a music wire having a cross section of a predetermined diameter.

5. A device as claimed in claim 2, characterized in that said arms are defined by respective bent ends of said spring, which rest laterally on respective opposite faces of the retaining seat, which faces are parallel at all times to the tangents to said outer lateral surface of said pin, so as to exert on at least one of said arms, as a consequence of relative rotation in any direction of the rotationally connected said members, a torque reaction which elastically increases the winding diameter of the coil defined by said coil spring.

6. A device as claimed in claim 1, characterized in that the two rotationally connected said members are connected to each other by a pin defining said hinge axis and inserted coaxially through said substantially cylindrical support.

7. A device as claimed in claim 1, characterized in that the two rotationally connected said members are defined by a fixed half-hinge and a movable half-hinge, which are connectable to a door or lid and to a post of an access opening opened/closed by the door or lid.

8. A hinge device, in particular for a lid of a vehicle glove compartment, characterized by comprising at least two half-hinges connected rotationally to each other by a hinge axis; and a retarding device as claimed in claim 1.
